(19) United States
(12) Patent Application Publication
(10) Pub. No.: US 2025/0139431 A1
(43) Pub. Date: May 1, 2025

(54) ATTENTION NEURAL NETWORKS WITH GATED ATTENTION UNITS

(71) Applicant: Google LLC, Mountain View, CA (US)

(72) Inventors: Hanxiao Liu, Santa Clara, CA (US); Weizhe Hua, Ithaca, NY (US); Zihang Dai, Pittsburgh, PA (US); Quoc V. Le, Sunnyvale, CA (US)

(21) Appl. No.: 18/834,202

(22) PCT Filed: Jan. 30, 2023
(86) PCT No.: PCT/US2023/011905

§ 371 Date: Jul. 29, 2024

Related U.S. Application Data
(60) Provisional application No. 63/304,559, filed on Jan. 28, 2022.

(51) Int. Cl. G06N 3/08; G06N 3/048

(52) U.S. Cl. CPC G06N 3/08; G06N 3/048

(57) ABSTRACT

Methods, systems, and apparatus, including computer programs encoded on a computer storage medium, for performing a machine learning task on a network input to generate a network output. In one aspect, one of the systems includes a neural network configured to perform the machine learning task, the neural network including one or more attentive layers that each include a gated attention unit.

### CROSS-REFERENCE TO RELATED APPLICATIONS

This application claims the benefit of priority to U.S. Provisional Application Ser. No. 63/304,559, filed Jan. 28, 2022, the entirety of which is incorporated herein by reference.

### BACKGROUND

This specification relates to performing a machine learning task on a network input using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that generates network outputs for received network inputs using a neural network that includes one or more attentive layers. The one or more computers may comprise one or more machine learning accelerators, e.g., one or more TPUs, GPUs and/or other ASICs.

Instead of first applying an attention mechanism and then processing the output of the attention mechanism using a feed-forward neural network, each attentive layer includes a gated attention unit that “gates” the output of the attention mechanism as applied to an input sequence to the attentive layer and the output of one or more feed-forward layers as applied to the input sequence for the attentive layer.

Particular embodiments of the subject matter described in this specification can be implemented so as to realize one or more of the following advantages.

Large attention-based neural networks, e.g., neural networks having a Transformer architecture, yield impressive results on many machine learning tasks. Despite the fast-growing model size of these neural networks, many existing systems are limited to short context size due to the quadratic complexity of Transformers over the input length. This restriction fundamentally prevents the model from processing long-term information, a critical property for many complex machine learning tasks.

In particular, existing systems that apply self-attention to input sequences are constrained in the length of the input sequences that can be processed, i.e., constrained to processing input sequences have at most a certain number of elements. Here, an input sequence can refer to an input sequence for a task that is being performed or an already-generated portion of an output sequence that is required to be generated in order for the neural network to perform the task.

In particular, both the computational and memory requirements of applying self-attention across an entire input sequences grows quadratically with the number of elements in the input sequence (i.e., the computational and memory complexity is O(n²), where n is the number of elements in the input sequence). Thus, it can be infeasible to apply self-attention to an input sequence when n is too large, limiting these existing systems to small problem domains.

This specification describes a new attentive layer design which naturally enables higher-quality approximation. Specifically, the attentive layer that includes a gating mechanism to alleviate the burden of self-attention, resulting in the attentive layer being computationally cheaper and having its quality relying less on the precision of the attention mechanism. Thus, in some cases, the attentive layer can use an attention mechanism that approximates the quadratic attention mechanism of the Transformer, leading to a variant with linear complexity over the context size without memory bottlenecks.

In particular, the new attentive layer can be efficiently implemented on machine learning accelerators, e.g., TPUs, GPUs, or other ASICs, resulting in improved performance both in theory and when the neural network is deployed on one or more of these accelerators.

Moreover, for a given quality (e.g. as measured by a perplexity score), systems comprising an attentive layer as described in this specification can be trained (e.g. on one or more machine learning accelerators) in less time compared to known Transformer models, in particular when longer sequence lengths are used (e.g. sequence lengths longer than or equal to 512, such as sequence lengths ranging from 512 to 8192).

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 shows an example architecture of a gated attention unit within an attentive layer.

FIG. 3 is a flow diagram of an example process for processing an input using an attentive layer.

FIG. 4 is a flow diagram of an example process for performing mixed chunk attention.

Like reference numbers and designations in the various drawings indicate like elements.

### DETAILED DESCRIPTION

This specification describes a system implemented as computer programs on one or more computers in one or more locations that performs a machine learning task on a network input to generate a network output for the machine learning task.

The machine learning task can be any machine learning task that (i) operates on a network input that is an input sequence, (ii) generates a network output that is an output sequence, or (iii) both.

Some examples of machine learning tasks that the system can be configured to perform follow.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. As a particular example, the task may be a multi-lingual machine translation task, where a single neural network is configured to translate between multiple different source language—target language pairs. In this example, the source language text may be augmented with an identifier that indicates the target language into which the neural network should translate the source language text.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken. In the case of an audio processing task, the input to the neural network may comprise audio data (e.g. an audio signal), for example in the form of a sequence of audio data frames, which may be processed to perform the audio processing task (e.g. speech recognition).

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be an image generation task, where the input is a conditioning input, e.g., text, a lower-resolution image, or a partial image, and the output is a sequence of intensity value inputs for the pixels of an image. The aim of the image generation task may be to generate images from the same distribution as a distribution of samples in the training data which is conditional on the conditioning input (i.e. a conditional distribution).

As another example, the task can be an image processing task. For example, the input can be the intensity values of the pixels of the image or an encoded representation of the intensity values of the pixels generated by an encoder neural network, and the network output can be (i) an image classification output that classifies the input image into one of a plurality of object categories (ii) an object detection output, i.e., a sequence that specifies the coordinates of one or more bounding boxes in the image that are predicted to encompass objects or (iii) a segmentation output that classifies each pixel in the input image into one of a plurality of categories.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

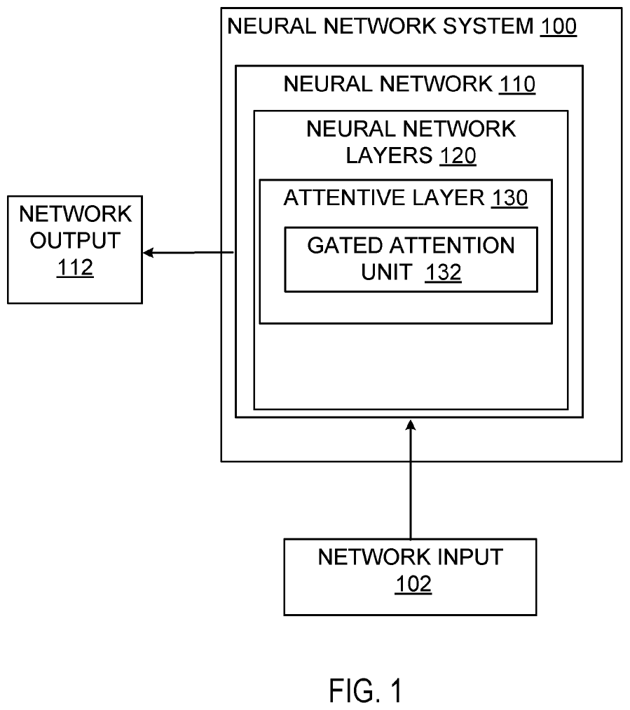

FIG. 1 shows an example neural network system 100. The neural network system 100 is an example of a system implemented as computer programs on one or more computers in one or more locations, in which the systems, components, and techniques described below can be implemented.

The system 100 is a system that processes a network input 102 using an attention neural network 110 to generate a network output 112 for a machine learning task, e.g., one of the tasks described above.

Generally, the neural network layers 120 within the attention neural network 110 include one or more initial neural network layers, e.g., an embedding layer and optionally one or more additional layers, a sequence of attentive layers 130, and one or more output layers that process the output of the last attentive layer 130 in the sequence as part of generating the network output 112.

As one example, when the network input 102 is an input sequence, the attention neural network 110 can process the network input 102 in a single forward pass to generate the network output 112.

As another example, when the network input 102 is an input sequence or has been mapped to an input sequence by an encoder neural network and the network output 112 is also a sequence that includes multiple elements, the attention neural network 110 can operate auto-regressively and generate the network output 112 over multiple time steps. At each time step, the attention neural network 110 processes the network input 102 (or the sequence generated from the network input 102) and the already generated elements of the output sequence to generate the next one or more elements of the output sequence.

Each attentive layer 130 operates on a respective input sequence that includes a respective layer input at each of one or more positions and includes a gated attention unit 132.

The gated attention unit 132 receives the input sequence for the layer 130 and applies an attention mechanism on the input sequence for the layer to generate an output sequence.

As one example, as described above, when the network input 102 is an input sequence, the attention neural network 110 can process the network input 102 in a single forward pass to generate the network output 112. In this example, the attentive layers 130 apply non-causal self-attention.

As another example, as described above, when the network input 102 is an input sequence or has been mapped to an input sequence by an encoder neural network and the network output 112 is also a sequence that includes multiple elements, the attention neural network 110 can operate auto-regressively and generate the network output 112 over multiple time steps. At each time step, the attention neural network 110 processes the network input 102 (or the sequence generated from the network input) and the already generated elements of the output sequence to generate the next one or more elements of the output sequence. In this example, the attentive layers 130 apply causal self-attention.

However, unlike conventional attention layers within conventional attention neural networks, the attentive layer 130 does not first apply an attention mechanism to the input to generate an attention output, and then apply further feed-forward transformations to the attention output to generate the output of the attentive layer 130.

Instead, the gated attention unit 132 also applies a set of feedforward transformation to the input sequence and then “gates” the output of the attention mechanism and the output of the feedforward transformations.

More specifically, the unit 132 generates a respective projected input for each layer input by processing the layer inputs using one or more “first” feed-forward neural network layers and applies an attention mechanism over the input sequence to generate a respective attended layer input for each layer input.

For example, the first feed-forward layers can include a linear layer followed by an activation function layer. The same first feed-forward layers are applied to each layer input, e.g., in parallel, to generate the projected layer input for each layer input.

In another example, the layer inputs can be chunked into multiple chunks, and a different set of first feed-forward layers can be applied to the layer inputs in each chunk, i.e., each chunk has a corresponding set of first feed-forward layers.

The unit 132 then generates a respective initial output for each layer input by computing an element-wise product between the respective projected input for the layer input and the respective attended layer input for the layer input, i.e., by “gating” the respective projected input with the respective attended layer input that has been determined based on at least some of the other layer inputs.

The unit 132 then generates the output of the unit 132 from the respective initial outputs. For example, the unit 132 can generate a respective updated output, i.e., a respective unit output, for each layer input by processing the initial outputs using one or more second feed-forward neural network layers.

For example, the second feed-forward layers can include a linear layer, optionally followed by an activation function layer, and the same second feed-forward layers can be applied for each layer input.

In another example, the layer inputs can be chunked into multiple chunks, and a different set of second feed-forward layers can be applied for the layer inputs in each chunk, i.e., each chunk has a corresponding set of second feed-forward layers.

The attention mechanism applied by the unit 132 depends on the configuration of the attention neural network 110, as will be described in more detail below.

In some cases, the output sequence generated by the unit 132 is the output sequence for the attentive layer 130 while in other cases the attentive layer 130 applies one or more transformations, e.g., residual connections, normalization operations, or both, to the output generated by the unit to generate the output sequence for the layer 130.

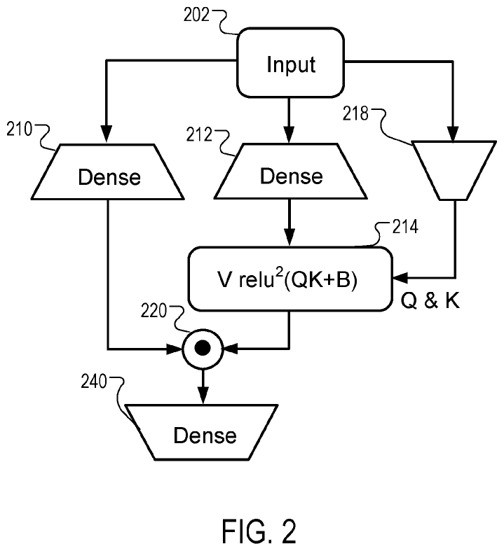

FIG. 2 shows the operation of a gated attention unit 132 within an attentive layer 130.

As shown in FIG. 2, the unit 132 receives an input sequence 202 for the layer 130 that includes a respective layer input at each of one or more positions.

Generally, the input sequence 202 is an intermediate representation of the current input to the attention neural network 110. That is, when the attention neural network 110 generates the network output 112 from the network input 102 in a single forward pass, the input sequence 202 is an intermediate representation of the network input 102. When network output 112 is a sequence and the neural network 110 generates the network output 112 over multiple time steps, the input sequence 202 is an intermediate representation of the already-generated network output 112 or of a combined sequence that includes the network input 112 and the already-generated network output 112.

The unit 132 generates a respective projected input for each layer input in the input sequence 202 by processing the layer inputs using one or more first feed-forward neural network layers. For example, the one or more first feed-forward neural network layers can include a dense layer 210, optionally followed by an element-wise activation function. A dense layer is a fully-connected neural network layer that has a dense weight matrix, i.e., that has not been constrained to have a certain proportion of values equal to zero.

The unit 132 applies an attention mechanism 214 over the input sequence to generate a respective attended layer input for each layer input. In particular, the unit 132 generates queries Q, keys K, and values V from the layer inputs in the input sequence 202 and then applies the attention mechanism using Q, K and V.

More specifically, the unit 132 generates a respective query and a respective key for each layer input by processing the layer inputs using one or more third feed- forward neural network layers; generates a respective value for each layer input by processing the layer inputs using one or more fourth feed-forward neural network layers, e.g., a dense layer 212; generates a respective set of attention weights for each layer input from the respective query for the layer input and the respective keys for the layer inputs; and for each layer input, applies the respective set of attention weights for the layer input to the respective values for the layer inputs.

For each layer input, the unit 132 then uses the attended layer input for the layer input to “gate” 220 the projected layer input. In other words, the unit 132 generates a respective initial output for each layer input by computing an element-wise product between the respective projected input for the layer input and the respective attended layer input for the layer input.

Thus, for each layer input, the unit 132 element-wise multiplies the output of the attention mechanism for the layer input with the output of a feed-forward operation on the layer input.

The unit 132 then generates the output sequence for the layer 130 from the respective initial outputs for the layer inputs. The output sequence for the layer 130 includes a respective layer output for each layer input.

In some implementations, the initial layer output for each layer input is the layer output for the layer input.

In some other implementations, the unit 132 generates a respective updated output for each layer input by processing the initial outputs using one or more second feed-forward neural network layers. For example, the one or more second feed-forward neural network layers can be another dense layer 240.

The layer 130 can then treat the respective updated outputs as the layer outputs for the layer inputs or can optionally further modify the respective updated outputs. For example, the layer 130 can generate the respective layer output for each layer input by applying a normalization operation, e.g., layer normalization, a residual connection, or both to the respective updated output for the layer input.

By utilizing the gating mechanism 220, the system alleviate the burden placed on the self-attention mechanism, i.e., the quality of the resulting network outputs is less reliant on the modeling capacity of the self-attention mechanism.

Therefore, the unit 132 can use a computational cheaper attention mechanism than the multi-head self-attention (MHSA) mechanism used by conventional attention neural networks in order to achieve comparable or better results.

One example of such an attention mechanism is shown in FIG. 2. In the example of FIG. 2, the system reduces the computational cost of attention in a variety of ways.

As one example, the system can compute the queries Q and keys K by applying a linear transformation 218 to the layer input, e.g., a multiplication with a dense weight matrix, to generate a shared representation Z and then applying per-dimension scale and shift transformations to each dimension of Z to generate Q and K. In some implementations, the scale and shift transformations can be the same learned transformation and the queries Q and the keys K can be equal to one another. In some other implementations, the system can learn separate per dimensional transformation for the queries Q and the keys K. Thus, rather than using separate dense matrices for both Q and K, the unit 132 can use a shared dense weight matrix.

In the example of FIG. 2, the unit 132 then computes the attention mechanism so that a matrix A that includes the respective sets of attention weights for the layer inputs satisfies:

$$A = r e l {u}^{2} ( Q {K}^{T} + b ) ,$$

where relu² is a squared ReLU element-wise activation function, Q is a matrix of the respective queries for the layer inputs, K is a matrix of the respective keys for the layer inputs, and b is a bias, e.g., a relative position bias.

As another example, the unit 132 can compute the attention mechanism so that a matrix A that includes the respective sets of attention weights for the layer inputs satisfies:

$$A = r e l {u}^{2} ( Q diag ( γ ) {K}^{T} + b ) ,$$

where relu² is a squared ReLU element-wise activation function, Q is a matrix of the respective queries for the layer inputs, diag(γ) is a diagonal matrix that has a vector γ along the diagonal and zeroes at all other entries, K is a matrix of the respective keys for the layer inputs, and b is a bias, e.g., a relative position bias.

In this example, rather than applying the per-dimensional scale and shift transformations, the system can set the queries Q and the keys K equal to one another by using the matrix Z as both Q and K. As one example, the system can use per-dimensional transformations during training to determine the parameters of the scale and shift transforms and then, after training, generate a diagonal matrix diag(γ) that results in the output of Zdiag(γ)Z^{T} being equal to QK^{T} and then apply the attention mechanism using Qdiag(γ)K^{T} with Q=K=Z.

While the above example attention mechanisms still have quadratic complexity over the sequence length, they reduce the computational cost of attention in a variety of ways.

As one example, the described attention mechanism is a single-head attention mechanism rather than the MHSA that is required by many conventional approaches.

As another example, the described attention mechanism uses an element-wise activation function (squared ReLU) instead of a more computationally expensive softmax as is required by many conventional approaches.

As yet another example, the dimensionality of the queries and keys can be reduced relative to the layer inputs, so that the multiplications required to generate the queries and generate the attention weights become computationally cheaper. For example, if each layer input has a dimensionality of 512, 768, or 1024, the query and keys can have dimensionality of 128, i.e., at least 4 times lower than the layer inputs.

Moreover, while not shown in FIG. 2, the use of the gating mechanism allows the unit 132 to implement an approximate attention mechanism that has less than quadratic complexity relative to sequence length.

For example, the attention unit can implement a partial attention mechanism, where the attention matrix A is constrained to be a sparse matrix. Examples of such attention schemes include local window attention, local+sparse attention, axial attention, and attention mechanisms that follow learnable patterns through hashing or clustering.

As another example, the attention unit can implement a linear attention mechanism that linearizes the attention computation by decomposing the attention matrix and then re-arranging the order of matrix multiplications. When applying a linear attention mechanism, the matrix that includes the respective sets of attended inputs for the layer inputs satisfies: Q(K^{T}V). This re-arrangement reduces the complexity with respect to sequence length from quadratic to linear.

As yet another example, the attention unit can approximate the original quadratic attention using mixed chunk attention, which merges the benefits from both partial attention and linear attention.

When mixed chunk attention is used, the layer inputs are partitioned into a plurality of chunks and then quadratic attention is applied within each chunk and linear attention is applied across chunks. Each chunk is a partition of the layer input sequence and includes a disjoint subset of the layer inputs from each other chunk. For example, the unit 132 or the layer 130 can divide the input sequence into chunks prior to processing the input sequence.

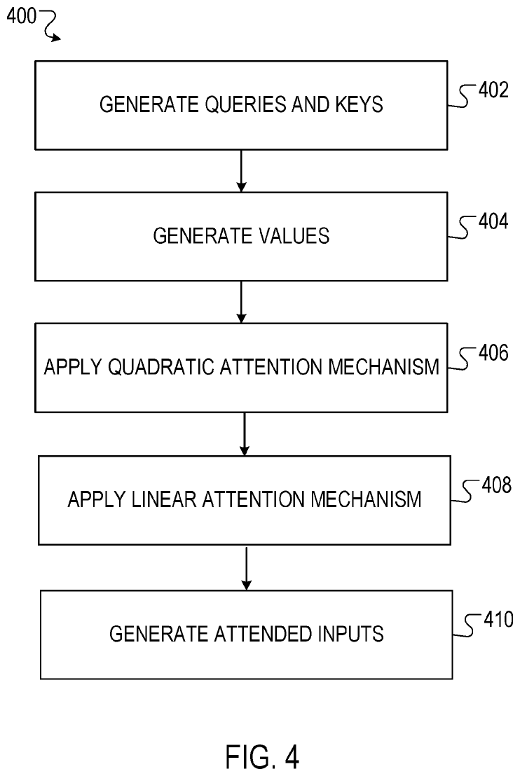

Applying mixed chunk attention is described in more detail below with reference to FIG. 4.

Moreover, when mixed chunk attention is used, the unit 132 can generate the projected layer inputs as described above or can generate the projected layer inputs independently for each chunk.

That is, the one or more first feed-forward neural network layers described above can include a respective set of one or more first feed-forward neural network layers for each chunk, and, for each chunk, the unit 132 can generate a respective projected input for each layer input in the chunk by processing the layer inputs in the chunk using the respective set of one or more first feed-forward neural network layers for the chunk. For example, the one or more first layers for each chunk can have the same architecture but, after training, different parameters.

Similarly, when mixed chunk attention is used, the unit 132 can generate the updated outputs as described above or independently for each chunk.

That is, the one or more second feed-forward neural network layers described above can include a respective set of one or more second feed-forward neural network layers for each chunk, and, for each chunk, the unit 132 can generate a respective updated output for each layer input in the chunk by processing the initial layer outputs for the layer inputs in the chunk using the respective set of one or more second feed-forward neural network layers for the chunk. For example, the one or more second layers for each chunk can have the same architecture but, after training, different parameters.

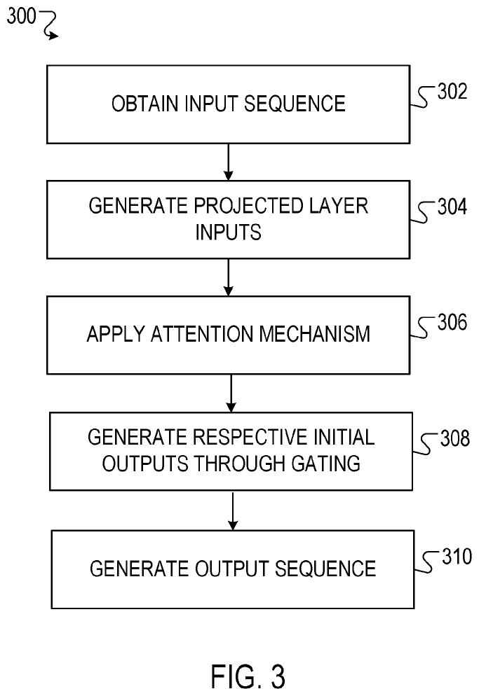

FIG. 3 is a flow diagram of an example process 300 for processing an input sequence to an attentive layer to generate an output sequence for the attentive layer. For convenience, the process 300 will be described as being performed by a system of one or more computers located in one or more locations. For example, an attentive layer included in a neural network system, e.g., one of the attentive layers 130 included in the neural network system 100 of FIG. 1, appropriately programmed, can perform the process 300.

The system obtains the input sequence for the layer (step 302). As described above, the input sequence has a respective layer input at each of one or more positions.

The system generates a respective projected input for each layer input by processing the layer inputs using one or more first feed-forward neural network layers (step 304).

The system applies an attention mechanism over the input sequence to generate a respective attended layer input for each layer input (step 306). As described above, in some implementations, the attention mechanism is one with quadratic complexity, but with reduced computational cost relative to conventional MHSA approaches. In some other implementations, the attention mechanism is an approximate attention mechanism with less than quadratic complexity. For example, the attention mechanism can be a local attention mechanism, a partial attention mechanism, or a mixed chunk attention mechanism as described in more detail below with reference to FIG. 4.

Additionally, as described above, in some implementations, the attention mechanism is a causal attention mechanism while, in other implementations, the attention mechanism is non-causal.

The system generates a respective initial output for each layer input by computing an element-wise product between the respective projected input for the layer input and the respective attended layer input for the layer input (step 308). That is, the system “gates” the respective projected input for the layer input with the respective attended layer input for the layer input.

The system generates the output sequence for the layer from the respective initial outputs for the layer inputs (step 310).

FIG. 4 is a flow diagram of an example process 400 for performing mixed chunk attention. For convenience, the process 400 will be described as being performed by a system of one or more computers located in one or more locations. For example, an attentive layer included in a neural network system, e.g., one of the attentive layers 130 included in the neural network system 100 of FIG. 1, appropriately programmed, can perform the process 400.

To apply the attention mechanism, the system can perform steps 402-406 for each chunk. For example, the system can perform steps 402-406 in parallel for each chunk.

The system generates a respective query and a respective key for each layer input in the chunk by processing the layer inputs using one or more third feed-forward neural network layers for the chunk (step 402).

In some implementations, the third feed-forward layers are the same for each chunk while in others, each chunk has its own set of feed-forward layers.

Additionally, in some implementations, the query and the key for each layer input in the chunk are the same. That is, the system processes the layer inputs using the one or more feed-forward layers for the chunk to generate a shared representation Z that is used as both the queries and the keys for the inputs in the chunk.

The system generates a respective value for each layer input in the chunk by processing the layer inputs using one or more fourth feed-forward neural network layers for the chunk (step 404). In some implementations, the fourth feed-forward layers are the same for each chunk while in others, each chunk has its own set of feed-forward layers.

The system applies a quadratic attention mechanism over the layer inputs in the chunk using the respective queries, keys, and values for the layer inputs in the chunk to generate a respective quadratic attended input for each layer input in the chunk (step 406).

In some implementations, as part of applying the quadratic attention mechanism, the system applies per-dimension parameters, e.g., the per-dimension scale and shift parameters, to the queries and the keys.

In particular, the system generates a respective set of attention weights for each layer input in the chunk from the respective query for the layer input and the respective keys for the layer inputs in the chunk using an appropriate quadratic attention mechanism and, for each layer input, applies the respective set of attention weights for the layer input to the respective values for the layer inputs to generate the respective quadratic attended input for the layer input

The system can apply any appropriate quadratic attention mechanism within the chunk.

For example, the system can apply one of the two examples of quadratic attention mechanisms described above.

That is, as one example, a matrix A_{g} that includes the respective sets of attention weights for the layer inputs in the chunk g satisfies:

$${A}_{g} = r e l {u}^{2} ( {Q}_{g} diag ( γ ) {K}_{g}^{T} + b ) ,$$

where relu² is a squared ReLU element-wise activation function, Q_{g} is a matrix of the respective queries for the layer inputs in the chunk g, diag(γ) is a diagonal matrix that has a vector γ along the diagonal and zeroes at all other entries, K_{g} is a matrix of the respective keys for the layer inputs in the chunk g, and b is a bias.

As another example, a matrix A_{g} that includes the respective sets of attention weights for the layer inputs in the chunk g satisfies:

$${A}_{g} = r e l {u}^{2} ( {Q}_{g} {K}_{g}^{T} + b ) ,$$

where relu² is a squared ReLU element-wise activation function, Q_{g} is a matrix of the respective queries for the layer inputs in the chunk g, K_{g} is a matrix of the respective keys for the layer inputs in the chunk g, and b is a bias.

As described above, in some implementations, the system can use the second example attention mechanism during training while using the first attention mechanism after training.

The system applies a linear attention mechanism across the plurality of chunks to generate a respective linear attended input for each layer input (step 408).

In some implementations, as part of applying the quadratic attention mechanism, the system applies per-dimension parameters, e.g., the per-dimension scale and shift parameters, to the queries and the keys. In particular, the linear and quadratic attention mechanisms can have different per-dimension parameters as a result of the training of the neural network.

For example, the system can apply the linear attention mechanism such that a matrix \hat{V}_{g}^{lin} of the linear attended inputs for the layer inputs in chunk g generated by applying the linear attention mechanism satisfies:

$${\hat{V}}_{g}^{lin} = {Q}_{g} diag ( λ ) ( {Σ}_{h = 1}^{T / C} {K}_{g}^{T} {V}_{h} ) ,$$

where Q_{g} is a matrix of the respective queries for the layer inputs in the chunk g, diag(λ) is a diagonal matrix that has a vector λ along the diagonal and zeroes at all other entries, T is a total number of layer inputs in the input sequence, C is the number of layer inputs in each chunk, K_{g} is a matrix of the respective keys for the layer inputs in the chunk g, and Vₕ is a matrix of the respective values for the layer inputs in the chunk h.

As another example, the system can apply the linear attention mechanism such that a matrix \hat{V}_{g}^{lin} of the linear attended inputs for the layer inputs in chunk g generated by applying the linear attention mechanism satisfies:

$${\hat{V}}_{g}^{lin} = {Q}_{g} ( {Σ}_{h = 1}^{T / C} {K}_{g}^{T} {V}_{h} ) ,$$

where Q_{g} is a matrix of the respective queries for the layer inputs in the chunk g, diag(λ) is a diagonal matrix that has a vector λ along the diagonal and zeroes at all other entries, T is a total number of layer inputs in the input sequence, C is the number of layer inputs in each chunk, K_{g} is a matrix of the respective keys for the layer inputs in the chunk g, and Vₕ is a matrix of the respective values for the layer inputs in the chunk h.

As described above, in some implementations, the system can use the second example attention mechanism during training while using the first attention mechanism after training.

As described above, in some implementations, the attentive layer applies causal self-attention.

In these cases, both the quadratic attention mechanism and the linear attention mechanism are causal.

In particular, the linear attention mechanism is a causal attention mechanism that attends only across chunks that are before chunk g in an order of the chunks. For example, the system can apply the linear attention mechanism such that a matrix \hat{V}_{g}^{lin} of the linear attended inputs for the layer inputs in chunk g generated by applying the linear attention mechanism satisfies:

$${\hat{V}}_{g}^{lin} = {Q}_{g} diag ( λ ) ( {Σ}_{h = 1}^{g - 1} {K}_{g}^{T} {V}_{h} ) ,$$

where Q_{g} is a matrix of the respective queries for the layer inputs in the chunk g, diag(λ) is a diagonal matrix that has a vector λ along the diagonal and zeroes at all other entries, K_{g} is a matrix of the respective keys for the layer inputs in the chunk g, and Vₕ is a matrix of the respective values for the layer inputs in the chunk h.

As another example, the system can apply the linear attention mechanism such that a matrix \hat{V}_{g}^{lin} of the linear attended inputs for the layer inputs in chunk g generated by applying the linear attention mechanism satisfies:

$${\hat{V}}_{g}^{lin} = {Q}_{g} ( {Σ}_{h = 1}^{g - 1} {K}_{g}^{T} {V}_{h} ) ,$$

where Q_{g} is a matrix of the respective queries for the layer inputs in the chunk g, K_{g} is a matrix of the respective keys for the layer inputs in the chunk g, and Vₕ is a matrix of the respective values for the layer inputs in the chunk h.

As described above, in some implementations, the system can use the second example attention mechanism during training while using the first attention mechanism after training.

Similarly, the quadratic attention mechanism is a causal attention mechanism such that each position within the chunk does not attend to any positions that are after the position within the chunk. For example, the system can implement this causality by masking the matrix of attention weights A so that for any position i, the attention weights for all positions after the position i within the chunk are zero.

For each layer input, the system combines the respective linear attended input for the layer input and the respective quadratic attended input for layer input to generate the attended input for the layer input (step 410). For example, the system can add the respective linear attended input for the layer input and the respective quadratic attended input for layer input to generate the attended input for the layer input.

By combining the outputs of both the linear and quadratic attention, the system merges the benefits from both partial attention and linear attention. For example, when attention is causal, the system can attain significant training speedups relative to using linear attention across the whole input sequence while maintaining a constant per-step decoding and memory cost for each decoding step at inference. More generally, mixed chunk attention significantly reduces the compute in quadratic attention, while requiring substantially less sequential dependency than conventional linear attention. Because modern hardware accelerators, e.g., GPUs, TPUs, and other ASICs that perform matrix multiplication in hardware can perform addition and multiplication in hardware much faster than memory accesses to read new data from memory, the decrease in sequential dependency and the resulting decrease in the number of memory required to read data from previous steps from memory result in the described attention scheme being efficiently implemented on hardware accelerators both at inference and during training.

Thus, the described scheme is both theoretically efficient and actually efficient when deployed on one or more hardware accelerators.

While FIG. 4 describes that mixed chunk attention uses quadratic attention within chunks and chunked linear attention across chunks, in practice, any appropriate partial attention mechanism can be used in place of the quadratic attention, i.e., any appropriate partial attention mechanism can be combined with chunked linear attention as described above. For example, the quadratic attention described above can be replaced with a non-local partial attention mechanism or any other appropriate partial attention mechanism.

Prior to using the neural network to perform the machine learning task, a training system trains the neural network to perform the task, i.e., to determine trained values of the parameters of the neural network, i.e., of the layers in the sequence, the output layer(s), and the embedding layer used to generate the input to the first layer in the sequence. For example, the training system can train the neural network from scratch on training data for the task to minimize a loss function for the task, e.g., a cross-entropy loss, a negative log likelihood loss, and so on using conventional machine learning techniques. As another example, the training system can first pre-train the neural network on an unsupervised objective and then fine-tune the neural network on the training data for the task. As yet another example, the training system can train the neural network on both unlabeled data and the training data for the task through semi-supervised learning.

During training, the training system can incorporate any number of techniques to improve the speed, the effectiveness, or both of the training process. For example, the system can use dropout, label smoothing, or both to reduce overfitting. As another example, the system can perform the training using a distributed architecture that trains multiple instances of the neural network in parallel. Moreover, as described above, the system can first pre-train the neural network on a large unsupervised data set through unsupervised learning, e.g., to minimize a BERT loss or other unsupervised loss, and then fine-tune the neural network on task-specific training data to optimize the loss function for the task.

An “embedding,” as used in this specification is a vector of numeric values, e.g., floating point or other type of numeric values, that has a predetermined dimensionality, e.g., has a predetermined number of values.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system for performing a machine learning task on a network input to generate a network output, the system comprising one or more computers and one or more storage devices storing instructions that, when executed by the one or more computers, cause the one or more computers to implement:
an attention neural network configured to perform the machine learning task, the attention neural network comprising a plurality of attentive layers, each attentive layer configured to receive an input sequence for the layer and to generate an output sequence for the layer by performing operations comprising:
obtaining the input sequence for the layer, the input sequence comprising a respective layer input at each of one or more positions;
generating a respective projected input for each layer input by processing the layer inputs using one or more first feed-forward neural network layers;
applying an attention mechanism over the input sequence to generate a respective attended layer input for each layer input;
generating a respective initial output for each layer input by computing an element-wise product between the respective projected input for the layer input and the respective attended layer input for the layer input; and
generating the output sequence for the layer from the respective initial outputs for the layer inputs, wherein the output sequence for the layer includes a respective layer output for each layer input.

2. The system of claim 1, the operations further comprising:
generating a respective updated output for each layer input by processing the initial outputs using one or more second feed-forward neural network layers.

3. The system of claim 2, wherein the respective layer output for each layer input is the respective updated output for the layer input.

4. The system of claim 2, the operations further comprising:
generating the respective layer output for each layer input by applying a normalization operation, a residual connection, or both to the respective updated output for the layer input.

5. The system of claim 1, wherein applying an attention mechanism over the input sequence to generate a respective attended layer input for each respective layer input comprises:
generating a respective query and a respective key for each layer input by processing the layer inputs using one or more third feed-forward neural network layers;
generating a respective value for each layer input by processing the layer inputs using one or more fourth feed-forward neural network layers;
generating a respective set of attention weights for each layer input from the respective query for the layer input and the respective keys for the layer inputs; and
for each layer input, applying the respective set of attention weights for the layer input to the respective values for the layer inputs.

6. The system of claim 5, wherein the respective key and the respective value for each layer input are derived from a same shared representation generated by processing the layer inputs using the one or more third feed-forward neural network layers.

7. The system of claim 5, wherein the dimensionality of each query and key is smaller than the dimensionality of the layer inputs and the layer outputs.

8. The system of claim 5, wherein a matrix A that includes the respective sets of attention weights for the layer inputs satisfies:
$$A = rel {u}^{2} ( {Q}_{g} diag ( γ ) {K}_{g}^{T} + b ) ,$$
where relu² is a squared ReLU element-wise activation function, Q is a matrix of the respective queries for the layer inputs, diag(γ) is a diagonal matrix that has a vector γ along the diagonal and zeroes at all other entries, K is a matrix of the respective keys for the layer inputs, and b is a bias.

9. The system claim 8, wherein b is a relative position bias.

10. The system of claim 1, wherein the attention mechanism is a linear attention mechanism.

11. The system of claim 1, wherein the attention mechanism is a partial attention mechanism.

12. The system of claim 1, wherein the layer inputs are partitioned into a plurality of chunks, and wherein applying an attention mechanism over the input sequence to generate a respective attended layer input for each respective layer input comprises;
for each chunk:
generating a respective query and a respective key for each layer input in the chunk by processing the layer inputs using one or more third feed-forward neural network layers for the chunk;
generating a respective value for each layer input in the chunk by processing the layer inputs using one or more fourth feed-forward neural network layers for the chunk; and
applying a quadratic attention mechanism over the layer inputs in the chunk using the respective queries, keys, and values for the layer inputs in the chunk to generate a respective quadratic attended input for each layer input in the chunk; and
applying a linear attention mechanism across the plurality of chunks to generate a respective linear attended input for each layer input; and
for each layer input, combining the respective linear attended input for the layer input and the respective quadratic attended input for layer input to generate the attended input for the layer input.

13. The system of claim 12, wherein combining the respective linear attended input for the layer input and the respective quadratic attended input for layer input to generate the attended input for the layer input comprises adding the respective linear attended input for the layer input and the respective quadratic attended input for layer input to generate the attended input for the layer input.

14. The system of claim 12, wherein applying a quadratic attention mechanism over the layer inputs in the chunk using the respective queries, keys, and values for the layer inputs in the chunk to generate a respective quadratic attended input for each layer input in the chunk comprises:
generating a respective set of attention weights for each layer input in the chunk from the respective query for the layer input and the respective keys for the layer inputs in the chunk; and
for each layer input, applying the respective set of attention weights for the layer input to the respective values for the layer inputs to generate the respective quadratic attended input for the layer input, wherein a matrix A_{g} that includes the respective sets of attention weights for the layer inputs in the chunk g satisfies:
$${A}_{g} = r e l {u}^{2} ( {Q}_{g} diag ( γ ) {K}_{g}^{T} + b ) ,$$
where relu² is a squared ReLU element-wise activation function, Q_{g} is a matrix of the respective queries for the layer inputs in the chunk g, diag(γ) is a diagonal matrix that has a vector γ along the diagonal and zeroes at all other entries, K_{g} is a matrix of the respective keys for the layer inputs in the chunk g, and b is a bias.

15. The system of claim 12, wherein a matrix \hat{V}_{g}^{lin} of the linear attended inputs for the layer inputs in chunk g generated by applying the linear attention mechanism satisfies:
$${\hat{V}}_{g}^{lin} = {Q}_{g} diag ( λ ) ( {Σ}_{h = 1}^{T / C} {K}_{g}^{T} {V}_{h} ) ,$$
where Q_{g} is a matrix of the respective queries for the layer inputs in the chunk g, diag(λ) is a diagonal matrix that has a vector λ along the diagonal and zeroes at all other entries, T is a total number of layer inputs in the input sequence, C is the number of layer inputs in each chunk, Kₕ is a matrix of the respective keys for the layer inputs in the chunk h, and Vₕ is a matrix of the respective values for the layer inputs in the chunk h.

16. The system of claim 12, wherein the linear attention mechanism is a causal linear attention mechanism, and wherein a matrix \hat{V}_{g}^{lin} of the linear attended inputs for the layer inputs in chunk g generated by applying the causal linear attention mechanism satisfies:
$${\hat{V}}_{g}^{lin} = {Q}_{g} diag ( λ ) ( {Σ}_{h = 1}^{g - 1} {K}_{g}^{T} {V}_{h} ) ,$$
where Q_{g} is a matrix of the respective queries for the layer inputs in the chunk g, diag(λ) is a diagonal matrix that has a vector λ along the diagonal and zeroes at all other entries, the sum is over the chunks that are before the chunk g in an ordering of the chunks for the causal linear attention mechanism, Kₕ is a matrix of the respective keys for the layer inputs in the chunk h, and Vₕ is a matrix of the respective values for the layer inputs in the chunk h.

17. The system of claim 12, wherein the one or more first feed-forward neural network layers include a respective set of one or more first feed-forward neural network layers for each chunk, and wherein
generating a respective projected input for each layer input by processing the layer inputs using one or more first feed-forward neural network layers comprises:
for each chunk, generating a respective projected input for each layer input in the chunk by processing the layer inputs in the chunk using the respective set of one or more first feed-forward neural network layers for the chunk.

18. The system of claim 17, the operations further comprising:
generating a respective updated output for each layer input by processing the initial outputs using one or more second feed-forward neural network layers, wherein the one or more second feed-forward neural network layers include a respective set of one or more second feed-forward neural network layers for each chunk, and wherein
generating a respective updated output for each layer input by processing the initial outputs using one or more second feed-forward neural network layers comprises:
for each chunk, generating a respective updated output for each layer input in the chunk by processing the initial outputs for the layer inputs in the chunk using the respective set of one or more second feed-forward neural network layers for the chunk.

19. The system of claim 1, wherein the neural network includes one or more initial layers, a sequence of the attentive layers, and one or more output layers.

20. The system of claim 19, wherein the initial layers include an embedding layer.

21. The system of claim 19, wherein the network output is a sequence, wherein the neural network auto-regressively generates the network output over multiple time steps, and wherein at each time step the neural network processes the network input and any already generated elements of the network output.

22. The system of claim 21, wherein the attention mechanism in each attentive layer is a causal attention mechanism.

23. The system of claim 22, wherein the linear attention mechanism is a causal linear attention mechanism, and wherein a matrix \hat{V}_{g}^{lin} of the linear attended inputs for the layer inputs in chunk g generated by applying the causal linear attention mechanism satisfies:
$${\hat{V}}_{g}^{lin} = {Q}_{g} diag ( λ ) ( {Σ}_{h = 1}^{g - 1} {K}_{g}^{T} {V}_{h} ) ,$$
where Q_{g} is a matrix of the respective queries for the layer inputs in the chunk g, diag(λ) is a diagonal matrix that has a vector λ along the diagonal and zeroes at all other entries, the sum is over the chunks that are before the chunk g in an ordering of the chunks for the causal linear attention mechanism, Kₕ is a matrix of the respective keys for the layer inputs in the chunk h, and Vₕ is a matrix of the respective values for the layer inputs in the chunk, wherein the quadratic attention mechanism within each chunk is causal.

24. The system of claim 19, wherein the network input is a sequence and wherein the attention mechanism in each attentive layer is non-causal.

25. One or more non-transitory computer storage media storing instructions that when executed by one or more computers cause the one or more computers to implement: an attention neural network configured to perform a machine learning task, the attention neural network comprising a plurality of attentive layers, each attentive layer configured to receive an input sequence for the layer and to generate an output sequence for the layer by performing operations comprising:
obtaining the input sequence for the layer, the input sequence comprising a respective layer input at each of one or more positions;
generating a respective projected input for each layer input by processing the layer inputs using one or more first feed-forward neural network layers;
applying an attention mechanism over the input sequence to generate a respective attended layer input for each layer input;
generating a respective initial output for each layer input by computing an element-wise product between the respective projected input for the layer input and the respective attended layer input for the layer input; and
generating the output sequence for the layer from the respective initial outputs for the layer inputs, wherein the output sequence for the layer includes a respective layer output for each layer input.

26. A method performed by one or more computers, the method comprising:
receiving a network input; and
processing the network input using an attention neural network to generate a network output for the network input, the attention neural network comprising a plurality of attentive layers, each attentive layer configured to receive an input sequence for the layer and to generate an output sequence for the layer by performing operations comprising:
obtaining the input sequence for the laver, the input sequence comprising a respective layer input at each of one or more positions;
generating a respective projected input for each layer input by processing the layer inputs using one or more first feed-forward neural network layers;
applying an attention mechanism over the input sequence to generate a respective attended layer input for each layer input;
generating a respective initial output for each layer input by computing an element-wise product between the respective projected input for the layer input and the respective attended layer input for the layer input; and
generating the output sequence for the layer from the respective initial outputs for the layer inputs, wherein the output sequence for the layer includes a respective layer output for each layer input.
